(19) United States
(12) Patent Application Publication
(10) Pub. No.: US 2025/0078652 A1
(43) Pub. Date: Mar. 6, 2025

(54) METHOD AND SYSTEM FOR MONITORING THE SURROUNDINGS OF A VEHICLE

(71) Applicant: Continental Automotive Technologies GmbH, Hannover (DE)

(72) Inventors: Sebastian Strunck, Niedernhausen (DE); Andreas Schirling, Darmstadt (DE)

(73) Assignee: Continental Automotive Technologies GmbH, Hannover (DE)

(21) Appl. No.: 18/726,677

(22) PCT Filed: Dec. 22, 2022
(86) PCT No.: PCT/DE2022/200315

§ 371 Date: Jul. 3, 2024

(30) Foreign Application Priority Data
Jan. 5, 2022 (DE) 10 2022 200 081.1

(51) Int. Cl. G08G 1/01; G01S 7/00; H04W 4/46

(52) U.S. Cl. CPC G08G 1/0141; G01S 7/003; G08G 1/0112; H04W 4/46

(57) ABSTRACT

A method for monitoring the surroundings of a vehicle, wherein the vehicle has at least one signal receiver, a communication device for receiving data messages from another road user and an evaluation circuit, comprises receiving a data message from another road user, wherein the data message contains sensor information from the other road user; using the signal receiver to receive signals, checking the plausibility of the data message from the other road user, wherein the plausibility check comprises a check by the evaluation circuit in order to determine whether the sensor information contained in the data message corresponds to the signals received by the signal receiver.

The invention relates to a method and a system for monitoring the surroundings of a vehicle.

Modern vehicles, in particular autonomously driving vehicles, rely on a comprehensive surroundings sensor system in order to obtain the most comprehensive possible picture of the immediate surroundings. For example, the vehicles have for this purpose active surroundings sensors which have a signal transmitter and a signal receiver. The signal transmitter emits a signal, such as an optical signal or an acoustic signal, that is reflected by an obstacle. The reflected signal is detected by the signal receiver. Statements about obstacles or other road users can be obtained from the characteristic of the reflected signal, for example from the propagation length of the signal, the angle of reflection or a change in frequency.

The information collected by a vehicle can further be combined into a data message and made available to other vehicles via a communication device. The data message can also contain information about the ego vehicle, for example its position and its direction of travel or route. With the aid of such a data message, vehicles can also obtain surroundings information that is not within the monitoring range of their own sensors. This allows the vehicles, for example, to drive more predictively or to react early to dangerous situations or the behavior of other vehicles.

Since the vehicle cannot check information that is not within the detection range of its own sensors, it must be ensured that the data message or the information from the other road user is very reliable. However, it is difficult to assess the reliability of the data messages from other road users or the information contained therein.

The object of the invention is to provide a method as well as a system that make it possible to check the plausibility of the information contained in such a data message.

To achieve the object, a method for monitoring the surroundings of a vehicle is provided, wherein the vehicle has at least one signal receiver, a communication device for receiving data messages from another road user and an evaluation circuit. The method has the following steps:
receiving a data message from another road user, wherein the data message contains sensor information from the other road user;
using the signal receiver to receive signals,
checking the plausibility of the data message from the other road user, wherein the plausibility check comprises a check by the evaluation circuit in order to determine whether the sensor information contained in the data message corresponds to the signals received by the signal receiver.

After receiving the data message as well as receiving the signals from the vehicle's own signal receiver, the evaluation circuit checks whether there are correspondences between the information contained in the data message and the information received with the signal receiver. The correspondences can be information about a vehicle that is both received by the signal receiver and contained in the data message. If information that is both contained in the data message and received by the signal receiver is determined, it is checked whether this information corresponds. If this is the case, it can be assumed that the other information contained in the data message has also been collected correctly and is therefore trustworthy and can be used by the evaluation circuit. The data message and the information contained therein are approved by the evaluation circuit and therefore can be used by the vehicle controller.

Preferably, the sensor information from the other road user is data from the surroundings sensors of the other road user. In this case, the check of the data message includes checking whether the data from these surroundings sensors have captured the ego vehicle. The signals captured by the signal receiver can be in this case signals from the vehicle's own surroundings sensors or signals from the vehicle's own driving sensor system, which detect the vehicle's own position and/or direction of travel and compare these with the information contained in the data message. The advantage of the comparison with the information contained in the data message about the ego vehicle is that no additional road users or objects need to be detected by the ego vehicle or the other road user. It is only necessary for the ego vehicle to be within the detection range of the other road user.

Preferably, the signals received with the signal receiver are signals from an active surroundings sensor of the other road user, wherein the active surroundings sensor has a signal transmitter and a signal receiver, in particular wherein the reception of the signals comprises a check in order to determine whether the signals come from another road user. The reception of the signals from the active surroundings sensor of the other road user is an indication that the ego vehicle is in the sensor range of the other road user and can thus be detected by the surroundings sensors of the other road user. The sensor information from the other road user that is sent with the data message must therefore also contain information about the ego vehicle. If this information about the ego vehicle is contained in the data message, it can be assumed that the surroundings sensors of the other road user capture the surroundings correctly and that the information in the data message is reliable and/or trustworthy.

For example, the signal receiver may be part of an active surroundings sensor of the vehicle. Since, in such an embodiment, the signals received with the signal receiver come from another road user, it is necessary to be able to distinguish the signals from the other road user from the signals from the vehicle's own signal transmitter. For example, the reception of the signals with the signal receiver comprises filtering in order to be able to reliably separate or distinguish the signals from the other road user from other signals, for example the signals from a vehicle's own signal transmitter. Thus, no additional signal receiver is required, but rather use is made of the signal receiver of a vehicle's own active surroundings sensor that can receive further signals in addition to the signals from the vehicle's own signal transmitter.

However, an additional, independent signal receiver may also be provided. This may have the advantage that such a signal receiver can have a broader reception characteristic than a signal receiver of an active surroundings sensor. In particular, this may be designed such that it can receive signals regardless of direction or in a wider reception range than a signal receiver of an active surroundings sensor.

In order to be able to reliably separate the signals from the other road user from the vehicle's own signals, the filtering comprises, for example, a comparison with the signals emitted by the vehicle. By detecting the characteristic of the vehicle's own signals, it is possible to better separate the vehicle's own signals from the signals from the other road user.

In addition, the reception of the signals by the signal receiver may comprise a detection of the signal characteristic, in particular the signal strength and/or a temporal portion or a periodization of the signal, in order to obtain or estimate additional information about the other road user. For example, the distance of the other road user can be estimated from the signal characteristic. The additional information can be compared with the sensor information contained in the data message from the other road user. If the information estimated from the signal characteristic corresponds to the information contained in the data message, the information in the data message can be classified as trustworthy.

For example, the distance of the other road user can be estimated from the signal characteristic. The estimated distance can be compared with the sensor information from the other road user. If the estimated distance corresponds to the distance contained in the data message, the information contained in the data message can be considered reliable.

To achieve the object, a system for monitoring the surroundings of a vehicle is further provided, having at least one signal receiver, a communication device for receiving data messages from another road user and an evaluation circuit. The evaluation circuit is designed to receive and check the plausibility of a data message from another road user using one of the methods described above.

The signal receiver may be part of an active sensor system of the vehicle consisting of the signal receiver and a signal transmitter, and so no additional sensors are required.

The signal receiver can be an acoustic, optical or electromagnetic signal receiver. The signals can be, for example, acoustic, optical or electromagnetic signals. Preferably, the signal receivers have the widest possible frequency range, so that as many signals as possible can be received. Preferably, however, a restriction to standardized frequency ranges can be made in order to avoid false detections and to improve the detection accuracy. If the signal receiver is part of an active surroundings sensor, the frequency range is preferably greater than the frequency range of the signal transmitter.

Further advantages and features will become apparent from the following description in connection with the appended drawings. In the drawings:

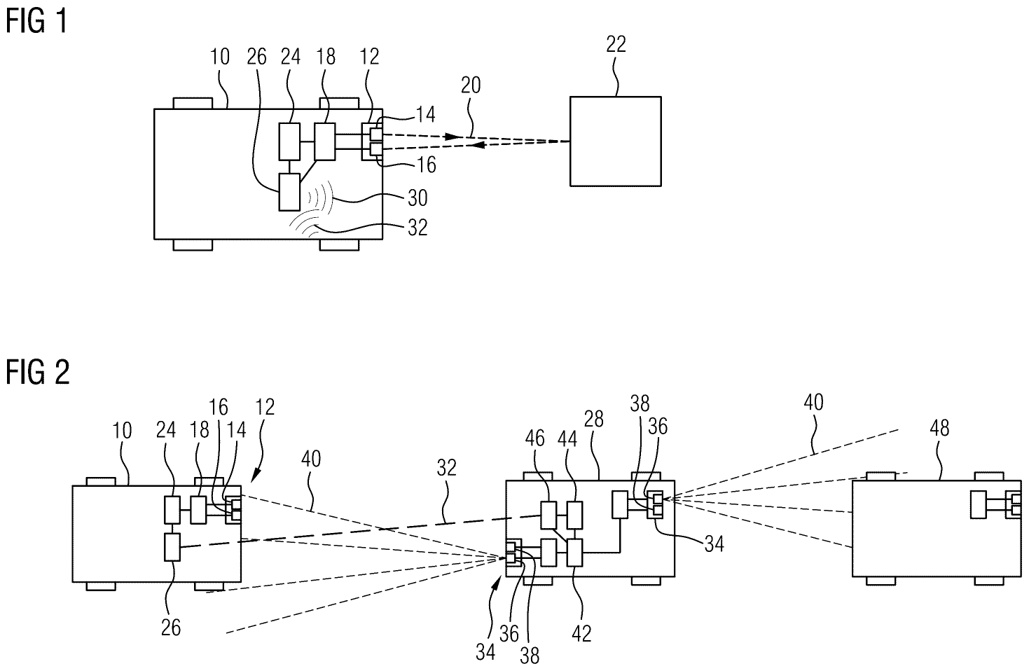

FIG. 1 shows a vehicle with an active surroundings sensor

FIG. 2 shows the vehicle from FIG. 1 with further road users.

FIG. 1 shows a vehicle 10 with an active surroundings sensor 12 consisting of a signal transmitter 14 and a signal receiver 16. The signal transmitter 14 and the signal receiver 16 are connected to an evaluation circuit 18. The signal transmitter 14 and the signal receiver 16 are integrated in a structural unit. However, these can also be arranged separately from one another in the vehicle.

The signal transmitter 14 can emit a signal 20. If this signal 20 hits an object 22, the signal 20 is reflected. The reflected signal 20 will be received by the signal receiver 16. From the propagation time or a phase measurement of the signal 20 from the signal transmitter to the signal receiver 16 and the direction of the reflected signal 20, the evaluation circuit 18 can determine the distance and the position of the object 22 and output corresponding information to a vehicle controller 24.

In this case, the signal 20 is an optical, acoustic or electromagnetic signal, for example a LIDAR signal (light detection and ranging) or a RADAR signal.

In principle, the signal receiver 16 in such systems is tuned to the signal or the frequency of the signal transmitter 14. Alternatively, the controller may have a filter that filters out the frequencies of the signal transmitter 14, with the result that only the signals from the signal transmitter 14 are processed.

The signal receiver 16 is designed to receive signals in a much larger frequency spectrum, with the result that other signals can also be received. Preferably, a filter is provided that can separate the signals 20 from the vehicle's own signal receiver 16 from other signals.

An additional signal receiver 16 can also be optionally provided. This may have the advantage that such a signal receiver 16 can have a broader reception characteristic than a signal receiver 16 of an active surroundings sensor 12. In particular, this may be designed such that it can receive signals regardless of direction or in a wider reception range than a signal receiver of an active surroundings sensor.

The vehicle 10 further has a communication device 26 for communicating with another road user 28 (see FIG. 2). The communication device 26 is connected to the evaluation circuit 18. Furthermore, a vehicle controller 24 is provided and is connected to the communication device 26 and the evaluation circuit 18.

The communication device 26 can transmit data messages 30, which contain the information from the surroundings sensor 12, to other road users 28 and/or can receive data messages 32 from other road users 28, these data messages containing sensor information from this road user 28, in particular also information from the surroundings sensors of this road user 28. The data messages 32 from the other road users can be processed in the evaluation circuit 18 or the vehicle controller 24 or taken into account thereby.

For example, the data message 30, 32 may contain information about the driving status of the other road user, for example the position, speed and direction of travel thereof. The vehicle controller 24 can compare this information with the driving status of the vehicle 10, for example, and can adapt the driving status, if necessary.

The data message from the other road user 28 may further contain information from the surroundings sensors 34 of the other road user 28. This allows the vehicle controller to also obtain traffic information or environmental information about areas that are not reachable with its own surroundings sensors 12, for example because these areas are hidden by other vehicles or objects or are not reachable by the orientation of the surroundings sensors 12.

FIG. 2 shows a further road user 28 likewise having surroundings sensors 34, each consisting of a signal transmitter 36 and a signal receiver 38. The signal transmitter 36 emits a signal 40 which strikes the vehicle 10 or a third road user 48 and is reflected thereby. The reflected signals 40 are received by the signal receivers 38, processed by the evaluation circuit 42 and output to a vehicle controller 44, with the result that the road user 28 can detect the position and the driving status of the vehicle 10 and the third road user.

The information from the surroundings sensor 34, and optionally further vehicle information from the other road user 28, such as its position or driving status, is combined by the vehicle controller 44 or the evaluation circuit 42 to form a data message 32 and is made available to other road users, for example the vehicle 10, via the communication device 46 of the other road user 28.

The vehicle 10 can receive this data message 32 and evaluate it in the vehicle controller 26.

At the same time, the signals 40 from the road user 28 are received by the signal receiver 16 of the vehicle 10. The evaluation circuit 18 separates the signals 20 from the vehicle's own signal receiver 16 and the other received signals 40 from each other.

The signal 40 is detected by the evaluation circuit 18 of the vehicle 10 as a signal from an active surroundings sensor of a further road user 22. Due to the lack of propagation time, it is not possible to determine a distance or a position from the received signal 40. Nevertheless, this signal can be used by the vehicle 10 to detect the presence of a further road user. Furthermore, this signal 30 is an indication that the surroundings sensor 34 of the other road user 28 has detected the vehicle 10.

The vehicle controller 26 or the evaluation circuit 18 can compare this information after receiving the data message 32 and the signal 40 and can check, for example, whether the data message 32 contains information about the vehicle 10. If the evaluation circuit 24 determines that the data message 32 contains information about the ego vehicle 10, that is to say there is a correspondence between information in the data message 32 and the received signals 40 from the signal receiver 16, this can be considered a plausibility check for the data message 32, and so its information can be classified as trustworthy.

The comparison with the data message 32 can also include other signals or information captured with the surroundings sensor 12. It is only necessary to determine a correspondence between the information contained in the data message 32 and the signals captured by the surroundings sensor 12. There is a correspondence between the information in the data message 32 and the signals from the signal receiver 16 when these provide corresponding information, that is to say information about an object or a signal can be obtained from both the data message 32 and the received signals and this information corresponds.

Preferably, the data message 32 and the signals from the surroundings sensor 12 are provided with a time stamp. The data message 32 is usually sent with a low latency. For the comparison of the data message 32 with the signals from the surroundings sensor, it is necessary to compare information that was acquired at the same time by the vehicle 10 and the other road user 28. If both the data message 32 or the information contained in the data message 32 and the signals from the vehicle's own surroundings sensor 12 are provided with a time stamp, information and data can be respectively provided with the same or a similar time stamp. Alternatively, a non-existent time stamp or a time delay can be estimated from other information received by the surroundings sensor 12.

For example, information about the driving status of the vehicle 10 may also be provided in order to compare it with the information in the data message 32. This makes it possible to check, for example, not only whether the ego vehicle 10 was detected by the other road user 28, but also whether the driving status of the vehicle 10 detected by the road user 28 corresponds to the driving status determined by the vehicle's own sensors.

The signal receiver 16 can also receive additional features of the signal 40 and output them to the evaluation circuit 18, for example in order to be able to make a rough distance estimation.

With some surroundings sensors, for example a radar, the signal 40 is very highly concentrated. In addition, the signal receiver is periodically swiveled in order to be able to scan as large an area as possible with the surroundings sensor. This also allows the direction in which an object 22 is located to be detected from the reflected signal. This may mean that the signal 30 is directed only in phases to the signal receiver 16 and can be received thereby. The distance between the signal transmitter 26 and the signal receiver 16 can be concluded from the time period over which the signal 40 is received by the signal receiver 16.

Furthermore, the strength of the signal 40 can be detected and can likewise be used to estimate the distance.

This information can also be used to compare the data message 32 and thus to check the plausibility of the data message 32.

In the embodiment described here, this is effected via the signal receiver 16 of the vehicle's own active surroundings sensor 12. Alternatively, however, separate signal receivers which are not part of an active surroundings sensor 12 may also be provided. For example, such signal receivers may be designed for a wider reception spectrum than the signal receiver 16 of the active surroundings sensor 12.

The signal receiver 16 is preferably selected depending on the respective signal type and the respective frequencies. For example, a Schottky diode connected to an antenna can be used to receive a radar signal. A high-frequency choke and filtering can be used to generate a DC voltage signal depending on the strength of the received signal 30. For example, the signal can be converted into a digital signal. For example, an APD diode or a PN diode or photomultiplier can be used for a LIDAR signal.

In the embodiment shown here, only one active surroundings sensor 12 and one signal receiver 16 are shown. However, the vehicle 10 may also have a plurality of active surroundings sensors 12, which are based on different signal types, and different signal receivers 16, which are designed to receive different signals, in particular different signal types.

1. A method for monitoring surroundings of a vehicle, wherein the vehicle comprises at least one signal receiver, a communication device for receiving data messages from another road user and an evaluation circuit, comprising:
receiving a data message from another road user, wherein the data message contains sensor information from the other road user;
using the signal receiver to receive signals,
checking plausibility of the data message from the other road user, wherein the plausibility check comprises a check by the evaluation circuit to determine whether the sensor information contained in the data message corresponds to the signals received by the signal receiver.

2. The method as claimed in claim 1, wherein the sensor information from the other road user is data from the surroundings sensors of the other road user.

3. The method as claimed in claim 2, wherein the signals received with the signal receiver are from an active surroundings sensor of the other road user,
wherein the active surroundings sensor has a signal transmitter and a signal receiver, and
wherein the reception of the signals comprises a check to determine whether the signals come from another road user.

4. The method as claimed in claim 3, wherein the reception of the signals comprises filtering.

5. The method as claimed in claim 4, wherein the filtering comprises a comparison with the signals emitted by the vehicle.

6. The method as claimed in claim 3, wherein the reception of the signals by the signal receiver comprises a detection of the signal characteristic, signal strength and/or a temporal portion or a periodization of the signal, and
wherein the signal characteristic is compared with the sensor information from the other road user.

7. The method as claimed in claim 6, wherein the distance of the other road user is estimated from the signal characteristic, and
wherein the estimated distance is compared with the sensor information from the other road user.

8. A system for monitoring the surroundings of a vehicle, having at least one signal receiver, a communication device for receiving data messages from another road user and an evaluation circuit, wherein the evaluation circuit is configured to receive and check the plausibility of a data message from another road user using a method as claimed in claim 1.

9. The system as claimed in claim 8, wherein the signal receiver is part of an active surroundings sensor of the vehicle consisting of the signal receiver and a signal transmitter.

10. The system as claimed in claim 8, wherein the signal receiver is an acoustic, optical and/or electromagnetic signal receiver.

11. The system as claimed in claim 9, wherein the signal receiver is an acoustic, optical and/or electromagnetic signal receiver.

12. The system as claimed in claim 8, wherein the sensor information from the other road user is data from a surroundings sensors of the other road user.

13. The system as claimed in claim 12, wherein the signals received with the signal receiver are from an active surroundings sensor of the other road user,
wherein the active surroundings sensor has a signal transmitter and a signal receiver, and
wherein the reception of the signals comprises a check to determine whether the signals come from another road user.

14. The system as claimed in claim 13, wherein the reception of the signals comprises filtering.

15. The system as claimed in claim 14, wherein the filtering comprises a comparison with the signals emitted by the vehicle.

16. The system as claimed in claim 13, wherein the reception of the signals by the signal receiver comprises a detection of the signal characteristic, signal strength and/or a temporal portion or a periodization of the signal, and
wherein the signal characteristic is compared with the sensor information from the other road user.

17. The system as claimed in claim 16, wherein a distance of the other road user is estimated from the signal characteristic, and
wherein the estimated distance is compared with the sensor information from the other road user.

18. The method as claimed in claim 14, wherein the reception of the signals by the signal receiver comprises a detection of the signal characteristic, signal strength and/or a temporal portion or a periodization of the signal, and
wherein the signal characteristic is compared with the sensor information from the other road user.

19. The method as claimed in claim 15, wherein the reception of the signals by the signal receiver comprises a detection of the signal characteristic, signal strength and/or a temporal portion or a periodization of the signal, and
wherein the signal characteristic is compared with the sensor information from the other road user.

20. The method as claimed in claim 4, wherein the reception of the signals by the signal receiver comprises a detection of the signal characteristic, signal strength and/or a temporal portion or a periodization of the signal, and
wherein the signal characteristic is compared with the sensor information from the other road user.
